(19) United States
(12) Patent Application Publication
(10) Pub. No.: US 2011/0080253 A1
(43) Pub. Date: Apr. 7, 2011

(54) Remote Control Apparatus

(76) Inventor: Tatsuro Sakamoto, Fukaya-shi (JP)

(21) Appl. No.: 12/857,347

(22) Filed: Aug. 16, 2010

(30) Foreign Application Priority Data
Oct. 5, 2009 (JP) 2009-231986

(51) Int. Cl. G05B 19/02; G06F 3/041

(52) U.S. Cl. 340/4.3; 345/173

(57) ABSTRACT

According to one embodiment, a remote control apparatus includes a first input module, a second input module, a transmit/receive module and a controller. The first input module is configured to input a gesture pattern. The second input module is configured to input starting of an application. The transmit/receive module is configured to transmit information on the gesture pattern and to transmit or receive a command. The controller is configured to activate the first input module if starting of a particular application is input via the second input module, to transmit a command requesting specification of an operation mode for the starting of the particular application after touch-on via the first input module, and to set the operation mode based on reception of a command specifying the operation mode.

### CROSS-REFERENCE TO RELATED APPLICATIONS

This application is based upon and claims the benefit of priority from Japanese Patent Application No. 2009-231986, filed Oct. 5, 2009; the entire contents of which are incorporated herein by reference.

### FIELD

Embodiments described herein relate generally to a remote control technique for operating screen display in response to an input.

### BACKGROUND

As is well known, in recent years, digitalization of television broadcasting has been promoted. For example, in Japan, not only satellite digital broadcasting such as BS (Broadcasting Satellite) digital broadcasting and 110 degree CS (Communication Satellite) digital broadcasting but also terrestrial digital broadcasting has been started. Against this background, much effort has been made to increase the level and range of functions of digital television broadcast reception apparatuses.

For example, a broadcast reception apparatus is connected to an external instrument via a network. By using a remote controller, a user can input an operation signal to the broadcast reception apparatus to perform an interlocked operation on the external instrument. Moreover, the user can utilize the Internet via the broadcast reception apparatus. In this case, the user uses the remote controller to move a pointer and input characters to the broadcast reception apparatus.

Furthermore, the user can reference an EPG (Electric Program Guide) screen displayed on the broadcast reception apparatus and set timer recording or select a desired program using the remote controller. With the increased level and range of the functions of the broadcast reception apparatus, there has been a demand for an increase in the range of functions of the remote controller.

Jpn. Pat. Appln. KOKAI Publication No. 2003-348371 discloses a configuration of a remote controller, which inputs a movement of a focus on an operation panel based on position information acquired by a movement of the user's finger on a trackpad.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block diagram schematically illustrating the configuration of a digital television broadcast reception apparatus according to an embodiment;

FIG. 2 is an exemplary diagram of the appearance of a remote controller according to the embodiment;

FIG. 3 is an exemplary block diagram schematically illustrating the configuration of the remote controller according to the embodiment;

FIG. 4 is an exemplary diagram illustrating an example of an operation on a touchpad of the remote controller according to the embodiment;

FIG. 5 is an exemplary diagram illustrating signal waveforms in the respective modes of the remote controller according to the embodiment;

FIG. 6 is an exemplary flowchart illustrating mode setting in the remote controller according to the embodiment;

FIG. 7 is an exemplary diagram illustrating a select screen for a link function according to the embodiment;

FIG. 8 is an exemplary diagram of a screen in multi-thumbnail display form illustrated when the link function is started;

FIG. 9 is an exemplary diagram illustrating a handwriting input screen according to the embodiment;

FIG. 10 is an exemplary diagram illustrating a select screen for an Internet function according to the embodiment;

FIG. 11 is an exemplary diagram of a browser screen displayed when the Internet function is started according to the embodiment;

FIG. 12 is an exemplary diagram of a screen illustrating a past program table according to the embodiment; and

FIG. 13 is an exemplary diagram illustrating a data broadcasting screen according to the embodiment.

### DETAILED DESCRIPTION

Various embodiments will be described hereinafter with reference to the accompanying drawings.

In general, according to one embodiment, a remote control apparatus includes a first input module, a second input module, a transmit/receive module and a controller. The first input module is configured to input a gesture pattern. The second input module is configured to input starting of an application. The transmit/receive module is configured to transmit information on the gesture pattern and to transmit or receive a command. The controller is configured to activate the first input module if starting of a particular application is input via the second input module, to transmit a command requesting specification of an operation mode for the starting of the particular application after touch-on via the first input module, and to set the operation mode based on reception of a command specifying the operation mode.

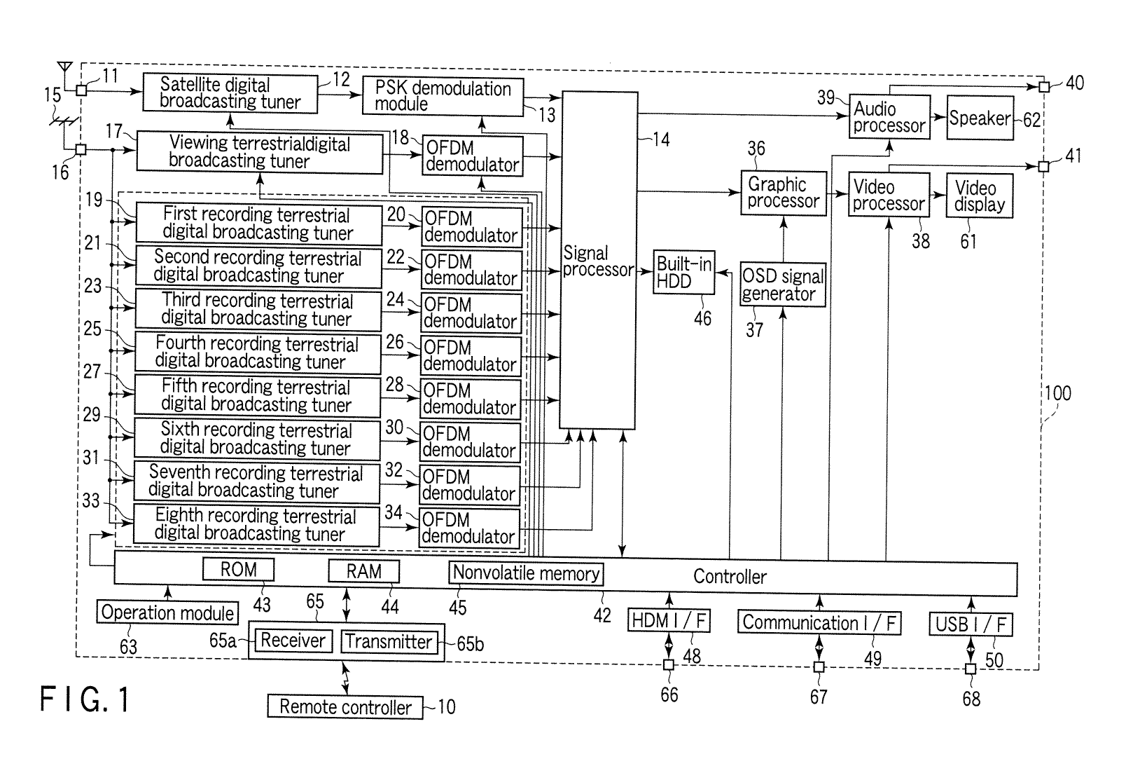

The embodiment will be described below with reference to the drawings. FIG. 1 is a block diagram schematically illustrating the configuration of a digital television broadcast reception apparatus 1 according to the embodiment. That is, a satellite digital television broadcasting signal received by an antenna configured to receive BS/CS digital broadcasting is supplied to a satellite digital broadcasting tuner 12 via an input terminal 11. The satellite digital broadcasting tuner 12 tunes in to a broadcasting signal for a desired channel.

The broadcasting signal tuned in by the satellite digital broadcasting tuner 12 is supplied to a PSK (Phase Shift Keying) demodulator 13. The PSK demodulator 13 then demodulates the signal into a digital video signal and a digital audio signal, and then outputs the signals to a signal processor 14.

Furthermore, a terrestrial digital television broadcasting signal received by an antenna 15 configured to receive terrestrial broadcasting is supplied to a viewing terrestrial digital broadcasting tuner 17 via an input terminal 16. The viewing terrestrial digital broadcasting tuner 17 switches and tunes in to a broadcasting signal for a user's desired channel. The broadcasting signal tuned in by the viewing terrestrial digital broadcasting tuner 17 is supplied to an OFDM (Orthogonal Frequency Division Multiplexing) demodulator 18. The OFDM demodulator 18 demodulates the broadcasting signal into a video signal and an audio signal and then outputs the signals to the signal processor 14.

A broadcasting signal tuned in by a first recording terrestrial digital broadcasting tuner 19 is supplied to an OFDM demodulator 20. The OFDM demodulator 20 demodulates the broadcasting signal into a video signal and an audio signal and then outputs the signals to the signal processor 14.

The above description also applies to a set of a second recording terrestrial digital broadcasting tuner 21 and an OFDM demodulator 22, a set of a third recording terrestrial digital broadcasting tuner 23 and an OFDM demodulator 24, a set of a fourth recording terrestrial digital broadcasting tuner 25 and an OFDM demodulator 26, a set of a fifth recording terrestrial digital broadcasting tuner 27 and an OFDM demodulator 28, a set of a sixth recording terrestrial digital broadcasting tuner 29 and an OFDM demodulator 30, a set of a seventh recording terrestrial digital broadcasting tuner 31 and an OFDM demodulator 32, and a set of an eighth recording terrestrial digital broadcasting tuner 33 and an OFDM demodulator 34.

In the description of the embodiment, the digital television broadcast reception apparatus 1 includes eight recording terrestrial digital broadcasting tuners. However, the digital television broadcast reception apparatus 1 may include at most seven or at least nine recording terrestrial digital broadcasting tuners.

The signal processor 14 selectively executes predetermined digital signal processing on the digital video and audio signals supplied by the PSK demodulator 13 and the OFDM demodulators 18, 20, 22, 24, 26, 28, 30, 32, and 34. The signal processor 14 then outputs the processed signals to a graphic processor 36 and an audio processor 39.

The graphic processor 36 has a function to superimpose an OSD (On Screen Display) signal generated by an OSD signal generator 37 on the digital video signal supplied by the signal processor 14. The graphic processor 36 can selectively output the output video signal from the signal processor 14 or the output OSD signal from the OSD signal generator 37, and combine both outputs such that the outputs form the respective halves of the screen.

The digital video signal output by the graphic processor 36 is supplied to a video processor 38. The video signal processed by the video processor 38 is supplied to a display 61 or an output terminal 41. The display 61 displays a video based on the video signal. When an external instrument is connected to the output terminal 41, the video signal supplied to the output terminal 41 is input to the external instrument.

Furthermore, the audio processor 39 converts an input digital audio signal into an analog audio signal in a format that can be reproduced by a speaker 62. The audio processor 39 then outputs the resulting signal to the speaker 62, which reproduces the corresponding sound and transmits the signal to an external instrument via an output terminal 40.

Here, the digital television broadcast reception apparatus 1 has all of its operations including the above-described various reception operations integrally controlled by a controller 42. The controller 42 contains CPU (Central Processing Unit) and the like. The controller 42 receives operation information from the operation module 63 or operation information transmitted by the remote controller 10 via a receiver 65a of a communication module 65, to control the relevant modules so that the contents of the operation are reflected in the control. The controller 42 transmits commands via a transmitter 65b of the communication module 65.

The controller 42 mainly utilizes ROM (Read Only Memory) 43 configured to store a control program executed by CPU, RAM (Random Access Memory) 44 configured to provide a work area for CPU, and a nonvolatile memory 45 configured to store various pieces of setting information and control information and the like.

A built-in HDD (Hard Disk Drive) 46 is connected to the signal processor 14. The built-in HDD 46 is configured to simultaneously store the video signal and audio signal for a program contained in the broadcasting signal tuned in by each of the first recording terrestrial digital broadcasting turner 19 to the eighth recording terrestrial digital broadcasting tuner 33. This operation is hereinafter referred to as multichannel simultaneous recording. The controller 42 carries out multichannel simultaneous recording based on a preset channel, day of the week, and time. In the description of the embodiment, the digital television broadcast reception apparatus 1 includes one built-in HDD. However, the digital television broadcast reception apparatus 1 may include two or more built-in HDDs.

In the embodiment, if the user uses the remote controller 10 to tune in to a desired channel, the viewing terrestrial digital broadcasting tuner 17 switches to the corresponding channel to tune in to the corresponding broadcasting signal. The display 61 displays a video of the program based on the broadcasting signal.

The first recording terrestrial digital broadcasting turner 19 to the eighth recording terrestrial digital broadcasting tuner 33 are each set to constantly tune in to the broadcasting signal for the channel corresponding to the channel specified by the user using the remote controller 10. From the first recording terrestrial digital broadcasting turner 19 to the eighth recording terrestrial digital broadcasting tuner 33 are each used as a recording tuner.

Furthermore, the controller 42 is connected to an HDMI terminal 66 via an HDMI (High Definition Multimode Interface) I/F 48. Thus, the controller 42 can transmit and receive information to and from an external instrument connected to the HDMI terminal 66.

Additionally, the controller 42 is connected to a LAN (Local Area Network) terminal 67 via a communication I/F 49. Thus, the controller 42 can transmit and receive information via the communication I/F 49 through a network connected to the LAN terminal 67.

Furthermore, the controller 42 is connected to a USB terminal 68 via a USB (Universal Serial Bus) I/F 50. Thus, the controller 42 can transmit and receive information to and from an external instrument connected to the USB terminal 68.

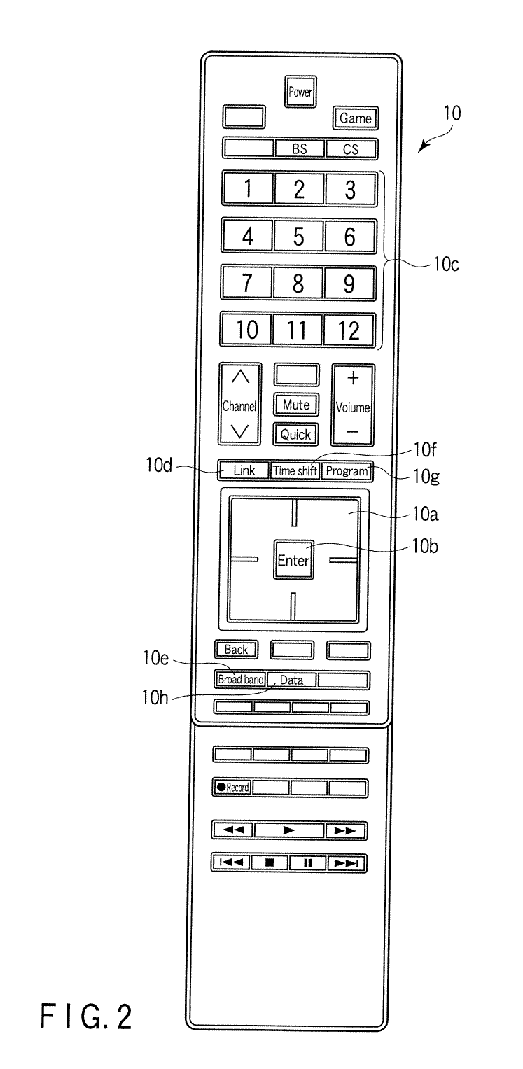

FIG. 2 is a diagram illustrating the appearance of the remote controller 10. The remote controller 10 mainly includes a touchpad 10a, an enter key 10b, a channel key 10c, a link key 10d, a broad band key 10e, a time shift key 10f, a program table key 10g, and a data key 10h.

The touchpad 10a is used to input gesture patterns described below. The user traces the touchpad 10a with the user's finger to input a gesture pattern. The touchpad 10a includes four portions located on the upper, lower, right, and left sides, respectively, of the touchpad in a normal use condition and serving as direction keys. The direction movement keys are provided in the area of the touchpad 10a. The enter key 10b is used to make selective determinations. The channel key 10c is used to select the channel of the broadcasting signal tuned in by, for example, the viewing terrestrial digital broadcasting tuner 17. The link key 10d is used to select an interlocked operation such as a read of data from the built-in HDD 46 or the external instrument connected to the digital television broadcast reception apparatus 1. The broad band key 10e is used to select an access to the Internet. The time shift key 10f is used to select display of the past program table corresponding to recorded programs stored in the built-in HDD 46 or a storage device such as HDD connected to the digital television broadcast reception apparatus 1. The program table key 10g is used to selectively display an EPG (Electric Program Guide) screen corresponding to a current or future program table. The data key 10h is used to select data broadcasting or satellite digital radio broadcasting.

The user can initially register the remote controller 10 with the digital television broadcast reception apparatus 1 by depressing a predetermined key. The user can set a call function for the remote controller 10 by depressing a predetermined key. The call function is such that if the user does not know where the remote controller 10 is, the user depresses a predetermined key on the operation module 63 of the digital television broadcast reception apparatus 1 to turn on a buzzer in the remote controller 10.

Furthermore, the user can set the speed of the operation of tracing the touchpad 10a with the user's finger. Moreover, the user can set turn-on and -off of the touchpad 10a by depressing a predetermined key.

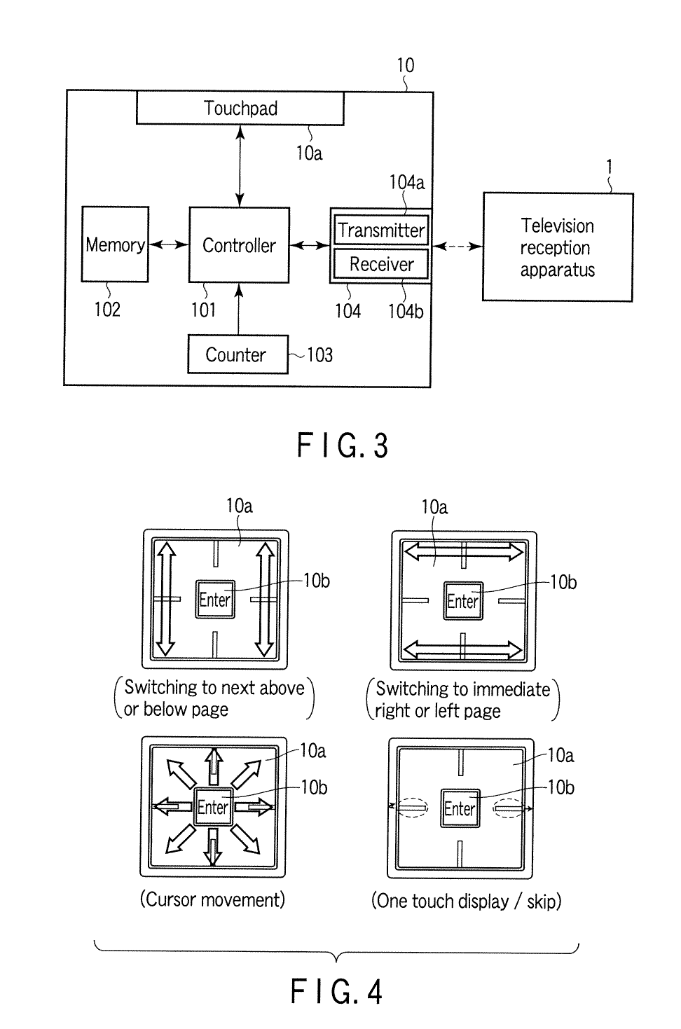

FIG. 3 is a block diagram schematically illustrating the configuration of the remote controller 10. The remote controller 10 includes the touchpad 10a, a controller 101, a memory 102, a counter 103, and a communication module 104. The communication module 104 includes a transmitter 104a and receiver 104b.

If the user traces the touchpad 10a with the user's finger to specify a gesture pattern, the touchpad 10a reads the gesture pattern. The controller 101 acquires touchpad data corresponding to trace information on a gesture pattern in which the user has traced the touchpad 10a. The controller 101 controls setting of the operation mode of the remote controller 10.

The memory 102 is configured to store commands corresponding to various keys such as the entry key 10b. Based on depression of any of the various keys, the controller 101 acquires the corresponding command from the memory 102. The counter 103 counts time. If a gesture pattern is input via the touchpad 10a, the transmitter 104a transmits a signal for touchpad data to the digital television broadcast reception apparatus 1 using, for example, infrared rays. Furthermore, if any of the various keys is depressed, the transmitter 104a transmits a signal for the corresponding command to the digital television broadcast reception apparatus 1. Moreover, the receiver 104b receives signals transmitted by the digital television broadcast reception apparatus 1.

FIG. 4 is a diagram illustrating an example of gesture pattern on the touchpad 10a. First, gesture patterns for movement of a cursor will be described. For example, to move the cursor upward on the screen of the display 61, the user traces the touchpad 10a upward from the position of the entry key 10b. The remote controller 10 outputs touchpad data to the digital television broadcast reception apparatus 1. The controller 42 of the digital television broadcast reception apparatus 1 can control the display 61 so that the display 61 shows the cursor moving upward. This also applies to the downward, leftward, rightward, upper rightward, lower rightward, upper leftward, and lower leftward movement of the cursor.

Now, a gesture pattern for switching to an upper page or a lower page will be described. For example, to switch to the page above next to the one displayed on the display 61, the user traces the touchpad 10a in a direction from a lower left position toward an upper left position or from a lower right position toward an upper right position without passing over the enter key 10b on the touchpad 10a. The remote controller 10 outputs touchpad data to the digital television broadcast reception apparatus 1. The controller 42 of the digital television broadcast reception apparatus 1 controls the display 61 so that the display 61 shows that the page is switched to the next above one. To switch to the next below page, the user traces the touchpad 10a in a direction from an upper left position toward a lower left position or from an upper right position toward a lower right position without passing over the enter key 10b on the touchpad 10a.

Now, a gesture pattern for switching to the left or right page will be described. To switch to the page on the immediate left of the one displayed on the display 61, the user the user traces the touchpad 10a in a direction from an upper right position toward an upper left position or from a lower right position toward a lower left position without passing over the enter key 10b on the touchpad 10a. To switch to the immediate right page, the user the user traces the touchpad 10a in a direction from an upper left position toward an upper right position or from a lower right position toward a lower left position without passing over the enter key 10b on the touchpad 10a.

Now, a gesture pattern for one touch replay/skip will be described. For example, to replay a recorded program reproduced and displayed on the display 61, the user taps the surface of a dashed portion on the left side of the touchpad 10a, two consecutive times instead of pressing the surface (double tap). For example, to skip a recorded program reproduced and displayed on the display 61, the user taps the surface of a dashed portion on the right side of the touchpad 10a, two consecutive times instead of pressing the surface.

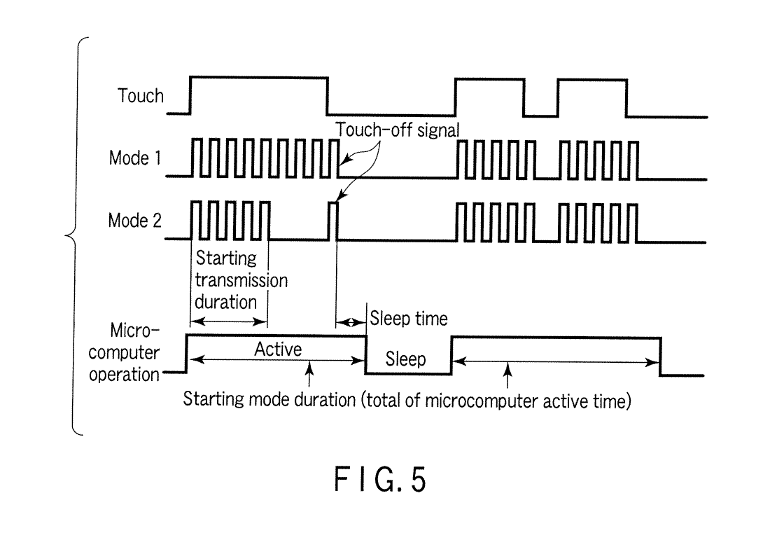

Now, setting of the operation mode of the remote controller 10 will be described. FIG. 5 is a diagram illustrating signal waveforms in the respective modes. The controller 101 switches the operation mode of the touchpad 10a to one of a mode 0, a mode 1, and a mode 2. The mode 0 (first mode) is a stop mode. In the mode 0, the touchpad 10a is inoperative. Thus, even when the user inputs a gesture pattern on the touchpad 10a set to the mode 0, the touchpad data is not read. Thus, the remote controller 10 does not transmit the touchpad data to the digital television broadcast reception apparatus 1.

The mode 1 (second mode) is a full mode. As shown in FIG. 5, when the user inputs a gesture pattern on the touchpad 10a set to the mode 1, the touchpad 10a reads the touch data. The remote controller 10 continuously transmits the touchpad data between touch-on and touch-off to the digital television broadcast reception apparatus 1.

The mode 2 (third mode) is an edge mode. As shown in FIG. 5, when the user inputs a gesture pattern on the touchpad 10a set to the mode 2, the touchpad 10a reads the touch data. After the operation mode of the remote controller 10 is set to the mode 2, the remote controller 10 continuously transmits the touchpad data to the digital television broadcast reception apparatus 1 for a given duration from the first touch-on. The duration is hereinafter referred to as a starting transmission duration (first continuous time). Between the end of the starting transmission duration and the touch-off, the operation of transmitting the touchpad data via the communication module 104 is set to a sleep state.

The controller 101 is set to the sleep state when in the mode 1 or 2, the touch-on is not carried out within a given time from the touch-off. After setting the mode 1 or 2 for the touchpad 10a, the controller 101 is in an active state except when the controller 101 in the sleep state. After setting the mode 1 or 2 for the touchpad 10a, the controller 101 allows the counter 103 to count the duration of the active state (microcomputer active state) as the preset duration of the operation mode. The duration is hereinafter referred to as the starting mode duration (second continuous time). The controller 101 continues the operation of transmitting the touchpad data via the communication module 104 during the active state.

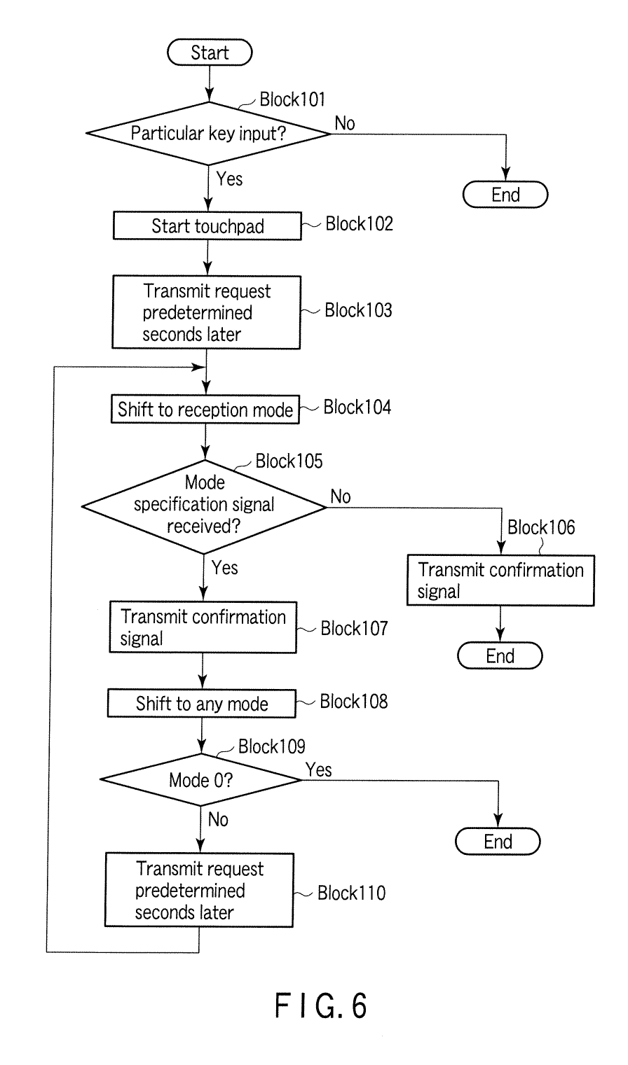

Now, mode setting for the remote controller 10 will be described. FIG. 6 is a flowchart illustrating the mode setting. The remote controller 10 is normally set to the mode 0.

First, the controller 101 determines whether or not any of the particular keys has been depressed (Block 101). The particular keys are, for example, the link key 10d, the broad band key 10e, the time shift key 10f, the program table key 10g, and the data key 10h. The particular keys are not limited to these. Any key may be defined as a particular key provided that the key requests the digital television broadcast reception apparatus 1 to start an application that requires the above-described input on the touchpad 10a. Alternatively, instead of depressing the particular key, the user may select starting of an application on a menu screen displayed on the display 61.

Upon determining that no particular key has been depressed, that is, upon determining that, for example, the channel key 10c has been depressed (Block 101, NO), the controller 101 terminates the setting of the operation mode of the remote controller 10.

Upon determining that any of the particular keys has been depressed (Block 101, YES), the controller 101 starts the touchpad 10a (Block 102). At this time, the controller 101 sets the initial operation mode of the remote controller 10 to the mode 2. The controller 101 sets, for example, the mode 2 with a starting transmission duration of 4 seconds and a starting mode duration of 10 seconds. Furthermore, the counter 103 counts the starting transmission duration and the starting mode duration. During the starting mode duration in which the operation mode of the remote controller 10 is set to the mode 2, the touchpad 10a is in a starting state.

At this time, the digital television broadcast reception apparatus 1, the controller 42 starts the application corresponding to the key depressed on the remote controller 10, and controllably displays the application on the display 61.

After the starting mode duration in the mode 2 elapses, the controller 101 transmits a command requesting specification of the operation mode of the remote controller 10 for the application being started in the digital television broadcast reception apparatus 1, to the digital television broadcast reception apparatus 1 via the communication module 104 (Block 103). Thereafter, the controller 101 shifts the remote controller 10 to a reception mode (Block 104). The controller 101 waits to receive a specification command for the operation mode from the digital television broadcast reception apparatus 1 via the communication module 104. That is, the controller 101 sets the operation of transmitting the touchpad data via the communication module 104, to the sleep state. The duration of the reception mode corresponds to a wait time for the user and is thus desirably shorter. For example, the duration of the reception mode is 500 milliseconds. Counting of the duration of the reception mode is started when the mode is shifted to the reception one.

Then, the controller 101 determines whether or not the specification command for the operation mode transmitted by the digital television broadcast reception apparatus 1 has been received in the reception mode (Block 105). Upon determining that the specification command for the operation mode has not been received (Block 105, NO), the controller 101 transmits a confirmation signal indicating that the specification command for the operation mode has not been received, to the digital television broadcast reception apparatus 1 via the communication module 104 (Block 106). The remote controller 10 cannot receive the specification command for the operation mode if for example, the user has used the remote controller 10 to select termination of the application being started in the digital television broadcast reception apparatus 1. Thus, the controller 101 sets the operation mode of the remote controller 10 to the mode 0 to terminate the process.

Upon determining that the specification command for the operation mode (Block 105, YES), the controller 101 shifts the operation mode of the remote controller 10 in accordance with the specification command for the operation mode (Block 107). The controller 101 transmits a confirmation signal indicating that the operation mode of the remote controller 10 has been shifted, to the digital television broadcast reception apparatus 1 via the communication module 104 (Block 108).

Then, the controller 101 determines whether or not the operation mode of the remote controller 10 has been shifted to the mode 0 (Block 109). Upon determining that the operation mode has been shifted to the mode 0 (Block 109, YES), the controller 101 terminates the setting of the operation mode of the remote controller 10.

Upon determining that the operation mode has not been shifted to the mode 0, that is, upon determining that the operation mode has been shifted to the mode 1 or 2 (Block 109, NO), the controller 101 transmits a command requesting specification of the operation mode of the remote controller 10, to the digital television broadcast reception apparatus 1 via the communication module 104 (Block 110). During the duration in which the operation mode of the remote controller is set to the mode 1 or 2, the touchpad 10a is in the starting state. The given duration from the first touch-on in the mode 2 varies among the applications and among the operations. Moreover, each of the durations of the modes 1 and 2 varies among the applications. The counter 103 counts the given duration and the mode duration.

Thereafter, the controller 101 returns to Block 104 to shift the remote controller 10 to the reception mode.

Now, setting of the operation mode of the remote controller will be described which setting is performed if the user has depressed any of the link key 10d, the broad band key 10e, the time shift key 10f, the program table key 10g, and the data key 10h as the particular key on the remote controller 10.

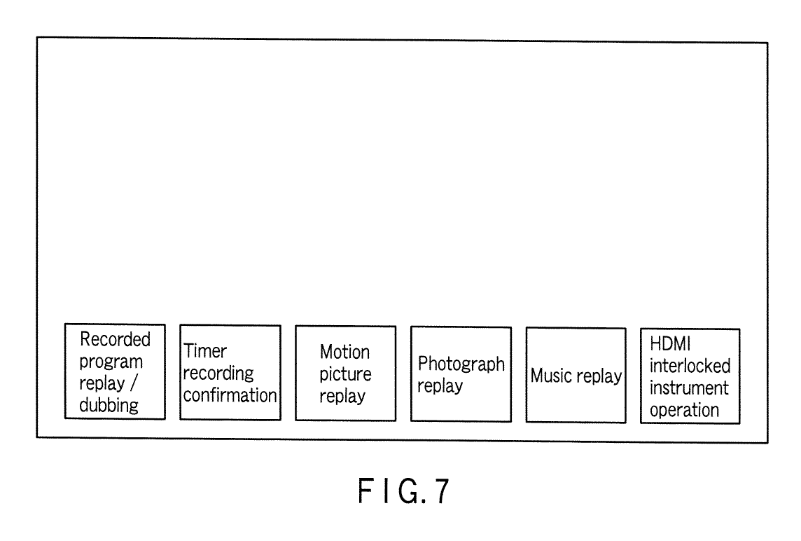

First, the case in which the user has depressed the link key 10d on the remote controller 10 will be described. FIG. 7 is a diagram of a link menu screen displayed on the display 61 of the digital television broadcast reception apparatus 1. The display 61 displays the link menu showing recorded program replay/dubbing, motion picture replay, photograph replay, timer recording confirmation, music replay, and HDMI interlocked instrument operation.

The recorded program replay/dubbing menu is designed to set replay or dubbing of a recorded program stored in the built-in HDD 46 or the storage device connected to the USB terminal 68. The motion picture replay menu is designed to set, via the LAN terminal 67, viewing of moving picture contents in any of various servers on the network. The photograph replay menu is designed to set display of a photograph stored in the built-in HDD 46, the storage device connected to the USB terminal 68, or a memory card or to set, via the LAN terminal 67, display of a photograph stored in any of the various servers on the network. The timer recording confirmation menu is designed to confirm timer recording of a program set in the built-in HDD 46 or the storage device connected to the USB terminal 68 or to delete the setting of the timer recording. The music replay menu is designed to set, via the LAN terminal 67, listening of music contents stored in any of the various servers on the network. The HDMI interlocked instrument operation menu is designed to operate an external instrument that can be operated in an interlocked manner, via the HDMI terminal 66.

On the link menu screen, the user can input, for example, the following operation as a gesture pattern on the touchpad 10a. For example, the operation input on the recorded program replay/dubbing menu is page switching on a timer recording list or one touch skip of the recorded program. The operation input on the motion picture replay menu is page switching on a motion picture list or one touch skip for motion picture replay. The operation input on the photograph replay menu is page switching on a photograph list. The operation input on the music replay menu is page switching on a music list or one touch skip for music replay.

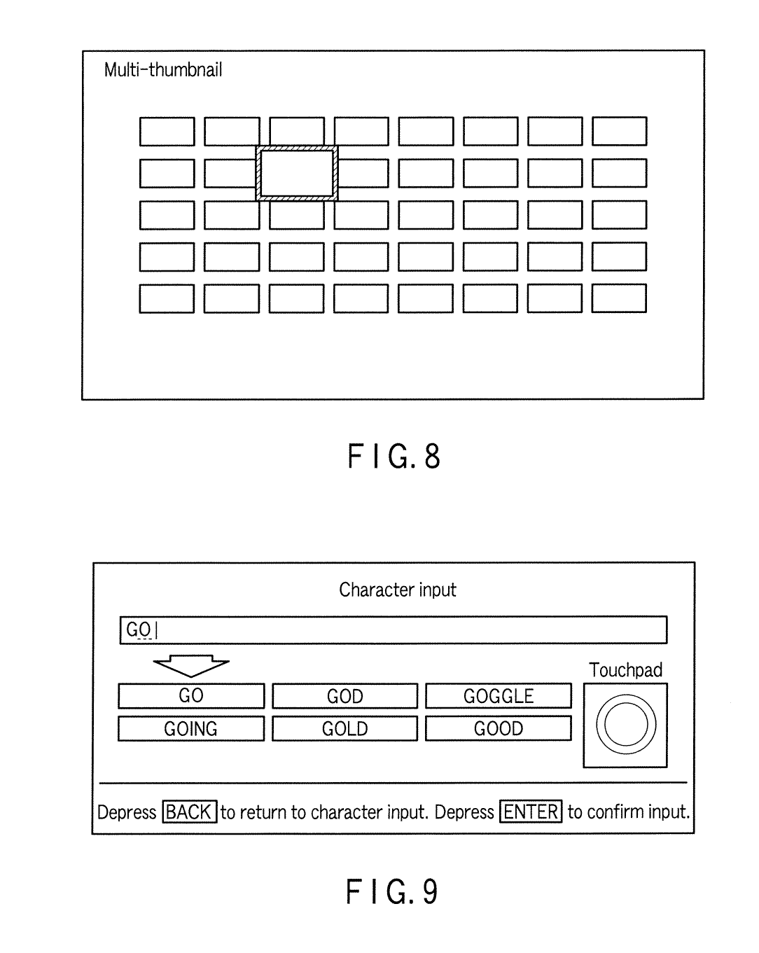

FIG. 8 is a diagram of a screen illustrated on the display 61 in multi-thumbnail display and showing recorded programs. When the user uses the remote controller 10 to select a recorded program replay/dubbing menu, the controller 42 displays the recorded programs stored in a selected instrument, on the display 61 in multi-thumbnail form. When the user traces the touchpad 10a in the gesture pattern illustrated in the cursor movement in FIG. 4, the cursor moves in any of eight directions on the multi-thumbnail display screen.

FIG. 9 is a diagram illustrating a handwriting character input screen. To request characters to be input on the link menu, the controller 42 controllably displays a character input screen on the display 61. The character input screen displays the touchpad 10a and the corresponding touchpad screen. When the user traces the touchpad 10a to handwrite characters, the controller 42 controllably displays the same trace as that of the finger on the touchpad 10a, on the touchpad screen on the character input screen. Every time the user input one character on the touchpad 10a, the controller 42 controllably lists conversion candidates on the character input screen.

As described above, if the user inputs characters on the touchpad 10a by hand, a long time is required for the operation from touch-on until completion of one input. On the other hand, if the user moves the cursor or inputs a command on the touchpad 10a, the amount of time required for this operation is shorter than that required for the character handwriting input operation from touch-on until completion of one input.

Thus, if the link key 10d is depressed, then in Block 102 of FIG. 6, the controller 101 sets the initial operation mode of the remote controller 10 to the mode 2 with a starting transmission duration of 4 seconds and a starting mode duration of 10 seconds. Moreover, if the application for the link menu is started, then in Block 107, for the character input, the controller 42 transmits a command specifying the mode 2 with a starting transmission duration of 4 seconds and a starting mode duration of 1 minute, as the operation mode. For the operations other than the character input, the controller 42 transmits a command specifying the mode 2 with a starting transmission duration of 1 second, which is shorter than in the case of character input, and a starting mode duration of 1 minute, as the operation mode.

That is, when the character input screen is shown on the display 61, provided that the mode 2 is set with a starting transmission duration of 4 seconds, the controller 101 can reliably transmit touchpad data for character input provided on the touchpad 10a by the user to the digital television broadcast reception apparatus 1. On the other hand, when a screen other than the character input screen is displayed on the display 61, even if the more 2 is set with a starting transmission duration of 1 second, the controller 101 can reliably transmit touchpad data for cursor movement or command input provided on the touchpad 10a by the user.

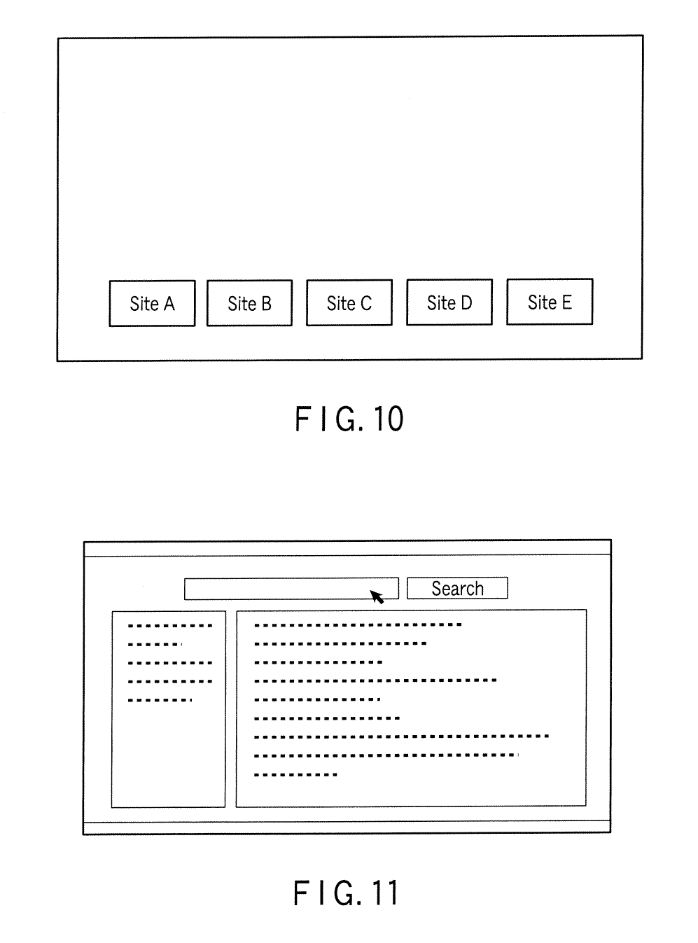

Now, the case where the user has depressed the broad band key 10e on the remote controller 10 will be described. FIG. 10 is a diagram of a broad band menu screen displayed on the display 61 of the digital television broadcast reception apparatus 1. The broad band menu with a site A to a site E is shown on the video display. The broad band menu includes a search site and a motion picture site.

In the broad band menu screen, the user can use movement of a free pointer for the browser, switching of the browser page, one-touch skip in a motion picture site, or handwriting input of characters as a gesture pattern on the touchpad 10a.

FIG. 11 is a diagram of a search site screen displayed on the display 61. When the user uses the remote controller 10 to select, for example, the site A, the controller 42 accesses the Internet via the LAN terminal 67 and displays a browser search site on the display 61. When the user traces the touchpad 10a in the gesture pattern shown for cursor movement in FIG. 4, the free pointer moves in any of the eight directions on the browser display screen. When the user traces the touchpad 10a in the gesture patter shown for switching to the next above or below page in FIG. 4, the browser display screen scrolls upward or downward.

As described above, if the user performs an input operation or inputs characters by hand on the touchpad 10a during browser display, a certain amount of time needs to elapse from touch-on until completion of one input. On the other hand, if the user moves the cursor or inputs a command on the touchpad 10a, the amount of time required for this operation is shorter than the amount of time from touch-on until completion of one input operation or Handwriting input of characters on the browser display screen.

Thus, if the broad band key 10e is depressed, then in Block 102 of FIG. 6, the controller 101 sets the initial operation mode of the remote controller 10 to the mode 2 with a starting transmission duration of 4 seconds and a starting mode duration of 10 seconds. Moreover, if the application for the broad band menu is started, then in Block 107, for the browser display and character input, the controller 42 transmits a command specifying the mode 1 with a starting mode duration of 10 minutes, as the operation mode. For the operations other than browser display and character input, the controller 42 transmits a command specifying the mode 2 with a starting transmission duration of 1 second and a starting mode duration of 10 minutes, as the operation mode.

That is, when the browser display screen or the character input screen is shown on the display 61, the mode 1 is set instead of the mode 2. Thus, even if a long time is required for the user's input on the touchpad 10a, the controller 42 can reliably transmit the touchpad data to the digital television broadcast reception apparatus 1. On the other hand, when a screen other than the browser display screen and the character input screen is shown on the display 61, even if the mode 2 is set with a starting transmission duration of 1 second, a long time is not required for the user's input on the touchpad 10a. Thus, the controller 101 can reliably transmit the touchpad data to the digital television broadcast reception apparatus 1.

If the application for the broad band menu is started, the user is assumed to perform a prolonged operation on the broad band menu. Thus, the controller 42 transmits the command specifying the mode 2 with a long starting mode duration of 10 minutes, to the remote controller 10. The set long duration eliminates the need for the remote controller 10 to perform transmission of the command requiring specification of the operation mode, reception of the specification command for the operation mode, and setting of the reception mode. This is effective for reducing power consumption and improving convenience for the user.

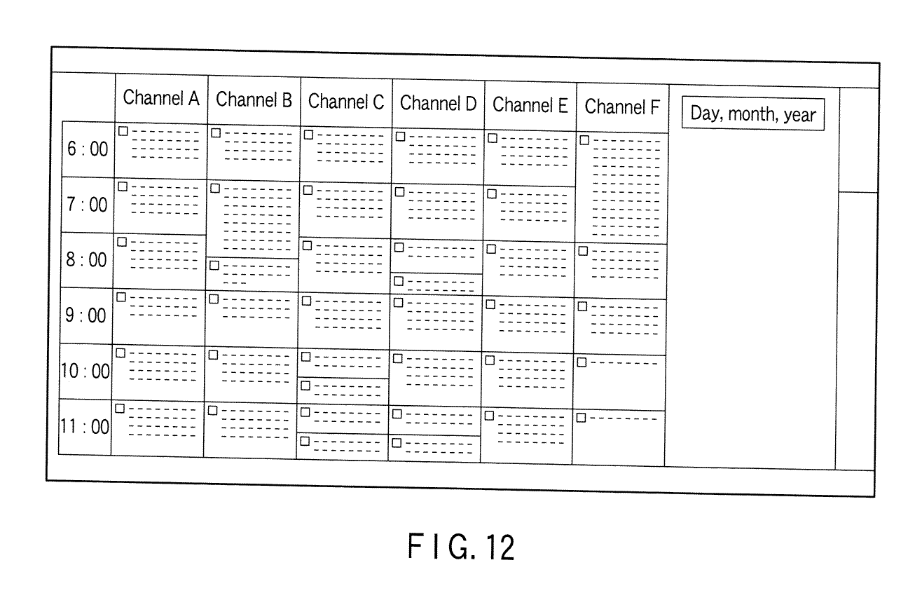

Now, the case where the user has depressed the time shift key 10f on the remote controller 10 will be described. FIG. 12 is a diagram of a past program table screen displayed on the display 61 of the digital television broadcast reception apparatus 1. The past program table lists the recorded programs stored in the built-in HDD 46 or the external storage device by multi-channel simultaneous recording, for each channel and for each time zone.

In the past program table screen, the user can use, for example, the cursor movement between past program sections, page switching on the past program table, or one touch skip of the recorded program as a gesture pattern on the touchpad 10a.

When the user traces the touchpad 10a with the user's finger in the gesture pattern shown for cursor movement in FIG. 4, the cursor moves between the past program sections on the past program table screen in any of the eight directions. When the user touches the touchpad 10a with the user's finger in the gesture pattern shown for switching to the next above or below page or to the immediate right or left page in FIG. 4, the browser display screen scrolls upward or downward or rightward or leftward.

As described above, when the user moves the cursor on the past program table on the touchpad 10a, a long time is required for the operation from touch-on until completion of one input. On the other hand, when the user performs an operation other than the cursor movement on the past program table on the touchpad 10a, the amount of time required for this operation is shorter than that required for the cursor movement operation from touch-on until completion of one input.

In Block 102 of FIG. 6, the controller 101 sets the initial operation mode of the remote controller 10 to the mode 2 with a starting transmission duration of 4 seconds and a starting mode duration of 10 seconds. Moreover, if the application for the past program table is started, then in Block 107, for the cursor movement on the past program table, the controller 42 transmits a command specifying the mode 2 with a starting transmission duration of 4 seconds and with a starting mode duration of 1 minute, to the remote controller 10 as the operation mode. For the operations other than the cursor movement on the past program table, the controller 42 transmits a command specifying the mode 2 with a starting transmission duration of 1 second and a starting mode duration of 1 minute, to the remote controller 10 as the operation mode.

That is, when the past program table is shown on the display 61, the controller 101 sets the operation mode with a starting transmission duration varying depending on whether or not the user performs the operation of moving the cursor on the past program table. Thus, the controller 101 can reliably transmit the touchpad data to the digital television broadcast reception apparatus 1.

In the above description, the user depresses the time shift key 10f. However, the above description also applies to depression of the program table key 10. If the program table key 10g is depressed, then in Block 102 in FIG. 6, controller 101 sets the initial operation mode of the remote controller 10 to the mode 2 with a starting transmission duration of 4 seconds and a starting mode duration of 10 seconds. Moreover, if the application for the current program table is started, then in Block 107, for the cursor movement on the current program table, the controller 42 transmits a command specifying the mode 2 with a starting transmission duration of 4 seconds and with a starting mode duration of 1 minute, to the remote controller 10 as the operation mode. For the operations other than the cursor movement on the current program table, the controller 42 transmits a command specifying the mode 2 with a starting transmission duration of 1 second and a starting mode duration of 1 minute, to the remote controller 10 as the operation mode.

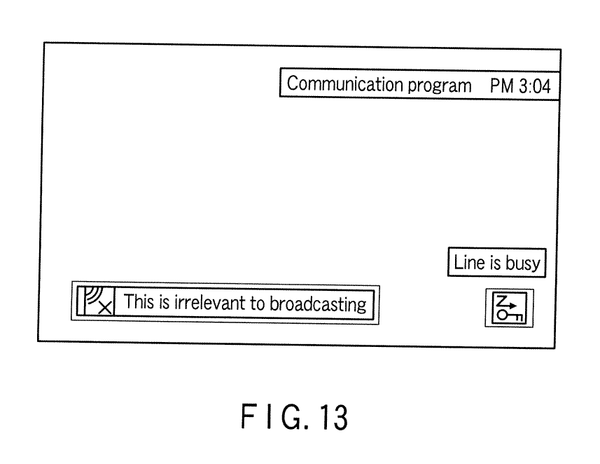

Now, the case where the user has depressed the data key 10h on the remote controller 10 will be described. FIG. 13 is a diagram of a data broadcasting screen shown on the display 61 of the digital television broadcast reception apparatus 1. The data broadcasting may be independent and irrelevant to programs or may be relevant to a television program. This also applies to radio broadcasting.

In the data broadcasting screen, the user can use, for example, one touch skip of link instrument operation or handwriting input of characters for data broadcasting as a gesture pattern on the touch pad 10a.

As described above, when the user inputs characters on the data broadcasting screen on the touch pad 10a by hand, a long time is required for the operation from touch-on until completion of one input. On the other hand, when the user performs an operation other than the handwriting input of characters on the touchpad 10a, the amount of time required for this operation is shorter than that required for the character handwriting input operation from touch-on until completion of one input.

Thus, if the time shift key 10f is depressed, then in Block 102 of FIG. 6, the controller 101 sets the initial operation mode of the remote controller 10 to the mode 2 with a starting transmission duration of 4 seconds and a starting mode duration of 10 seconds. Moreover, if the application for the data broadcasting is started, then in Block 107, for the handwriting input of characters, the controller 42 transmits a command specifying the mode 2 with a starting transmission duration of 4 seconds and with a starting mode duration of 1 minute, to the remote controller 10 as the operation mode. For the operations other than the handwriting input of characters, the controller 42 transmits a command specifying the mode 2 with a starting transmission duration of 1 second and a starting mode duration of 1 minute, to the remote controller 10 as the operation mode.

That is, when the data broadcasting is shown on the display 61, the controller 101 sets the operation mode with a starting transmission duration varying depending on whether or not the user performs the character input operation. Thus, the controller 101 can reliably transmit the touchpad data to the digital television broadcast reception apparatus 1.

According to the embodiment, an operational limit is imposed on the touchpad 10a depending on the application simply by the data communication between the remote controller 10 and the digital television broadcast reception apparatus 1 while the user is unconscious of this operation. The remote controller 10 enables the data communication started by the user's unintended touchpad 10a operation to be limited. This reduces the unwanted data communication between the remote controller 10 and the digital television broadcast reception apparatus 1. Moreover, the remote controller 10 does not request specification of the operation mode until the application is started. This enables a reduction in the number of data communications and in power consumption compared to the case where the specification of the operation mode is periodically requested at any timings. In the embodiment, when the user touches the touchpad 10a during starting, the controller 10 transmits a signal for the touchpad data corresponding to the trace of the finger, to the digital television broadcast reception apparatus 1. However, the embodiment is not limited to this configuration. For example, the following operation is possible: upon determining that the user has input such a preset gesture pattern as shown in FIG. 4 on the touchpad 10a, the controller 101 transmits a signal for the touchpad data corresponding to the input gesture pattern to the digital television broadcast reception apparatus 1. In this case, the remote controller 10 is prevented from transmitting a signal for touchpad data irrelevant to the operation of the application being started in the digital television broadcast reception apparatus 1. Therefore, the power consumption of the remote controller 10 can be reduced without hindering the user from operating the remote controller 10 easily.

A proximity sensor may be provided in the remote controller 10 according to the embodiment so as to detect the approach of the human finger to start the pad using the detection as a trigger. In this configuration, the approach of the human finger allows the touchpad 10a to be started. This enables prevention of a possible failure to read required information through the operation of the touchpad 10a. Furthermore, the proximity sensor can be used to start and stop the microcomputer, enabling a reduction in power consumption.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A remote control apparatus comprising:
a first input module configured to input a gesture pattern;
a second input module configured to input starting of an application;
a transmit/receive module configured to transmit information on the gesture pattern and to transmit or receive a command; and
a controller configured to activate the first input module if starting of a particular application is input via the second input module, to transmit a command requesting specification of an operation mode for the starting of the particular application after touch-on via the first input module, and to set the operation mode based on reception of a command specifying the operation mode.

2. The apparatus of claim 1, wherein the controller is configured to set the operation mode to one of a first mode in which an input via the first input module is not transmitted via the transmit/receive module, a second mode in which an input via the first input module lasting from the touch-on until touch-off is transmitted via the transmit/receive module, and a third mode in which an input via the first input module lasting for a first continuous time from the touch-on is transmitted via the transmit/receive module.

3. The apparatus of claim 2, wherein the controller is configured to set a second continuous time of the operation mode based on the command specifying the operation mode.

4. The apparatus of claim 3, wherein the controller is configured to set the first continuous time and the second continuous time, at least one of which varies between a first application and a second application, based on the command specifying the operation mode.

5. The apparatus of claim 3, wherein the controller is configured to set the third mode when the first input module is activated.

6. A broadcast reception apparatus comprising:
a receiver configured to receive a command for starting of a particular application and a command requesting specification of an operation mode for the starting of the particular application;
a controller configured to output display screen information for the particular application based on the command for the starting of the particular application; and
a transmitter configured to transmit a command specifying the operation mode for the starting of the particular application based on the command requesting the specification of the operation mode.

7. A mode setting method comprising:
activating a touchpad based on an input for starting of a particular application;
transmitting a command requesting specification of an operation mode for the starting of the particular application, after the touchpad is touched;
receiving a command specifying the operation mode; and
setting the operation mode based on the command specifying the operation mode.
